(19) United States
(12) Patent Application Publication
(10) Pub. No.: US 2025/0296442 A1
(43) Pub. Date: Sep. 25, 2025

(54) CONTENT OUTPUT CONTROL DEVICE, CONTENT OUTPUT CONTROL METHOD, AND STORAGE MEDIUM

(71) Applicant: HONDA MOTOR CO., LTD., Tokyo (JP)

(72) Inventors: Kentaro Yonei, Tokyo (JP); Yuto Kojima, Tokyo (JP); Masashi Akachi, Tokyo (JP)

(21) Appl. No.: 19/016,052

(22) Filed: Jan. 10, 2025

(30) Foreign Application Priority Data
Mar. 19, 2024 (JP) 2024-043790

(51) Int. Cl. B60K 35/81; B60K 35/10

(52) U.S. Cl. CPC B60K 35/81; B60K 35/10; B60K 2360/148; B60K 2360/741

(57) ABSTRACT

A content output control device includes: a degree-of-immersion reduction state recognition unit configured to recognize, based on biological information, that a user is in a degree-of-immersion reduction state indicating that a degree of immersion with respect to content output from a content output device is reduced; and an output content switching unit configured to execute content switching processing of switching, while first content is output from the content output device, when the user is recognized to be in the degree-of-immersion reduction state, the content output from the content output device to second content that is different from the first content.

### INCORPORATION BY REFERENCE

The present application claims priority under 35 U.S.C. § 119 to Japanese Patent Application No. 2024-043790 filed on Mar. 19, 2024. The content of the application is incorporated herein by reference in its entirety.

### BACKGROUND OF THE INVENTION

### Field of the Invention

The present invention relates to a content output control device, a content output control method, and a storage medium.

### Description of the Related Art

Hitherto, there has been proposed a technology of adjusting settings of a vehicle system based on a state of a user (a heart rate, a body temperature, a perspiration level, etc.) detected by a wearable device worn by the user riding on a vehicle (see, for example, Japanese Patent Laid-Open No. 2015-89808). Japanese Patent Laid-Open No. 2015-89808 describes, as the vehicle system, a vehicle climate control system (air conditioner or heater settings), an in-vehicle audio system (volume level and audio source settings), and a driver seat (an recline angle of the driver seat).

Incidentally, when a user riding on a vehicle views the content displayed on a display device of the vehicle, since the time to view the content is limited to within the riding time, when the content displayed on the display device does not match the preference or mood of the user, it is desired to promptly switch the displayed content to make the movement on the vehicle more comfortable. In view of the above, the present application has an object to promptly switch the content output from a content output device when the content output from the content output device used in a movable body such as a vehicle does not match the preference or mood of a user aboard the movable body.

In order to achieve the above-mentioned object, the present application aims to improve the operability. Moreover, the present application eventually further improves the traffic safety to contribute to development of a sustainable transportation system.

### SUMMARY OF THE INVENTION

As a first aspect for achieving the above-mentioned object, there is given a content output control device including: a biological information acquisition unit configured to acquire biological information of a user aboard a movable body; a degree-of-immersion reduction state recognition unit configured to recognize, based on the biological information, that the user is in a degree-of-immersion reduction state indicating that a degree of immersion with respect to content output from a content output device used in the movable body is reduced; and an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.

In the above-mentioned content output control device, the output content switching unit may be configured to switch, while the first content being video is output from the content output device, when the degree-of-immersion reduction state recognition unit recognizes that the user is in the degree-of-immersion reduction state, the first content to the second content that outputs only audio without outputting video by the content switching processing.

In the above-mentioned content output control device, the output content switching unit may be configured to execute switching from the first content to the second content by the content switching processing at a timing at which output of data of the first content is completed.

In the above-mentioned content output control device, the biological information acquisition unit may be configured to individually acquire biological information of a plurality of the users aboard the movable body, the degree-of-immersion reduction state recognition unit may be configured to recognize, for each of the plurality of the users, based on the biological information acquired by the biological information acquisition unit, the degree-of-immersion reduction state indicating that the degree of immersion with respect to the content output from the content output device used by the user is reduced, and the output content switching unit may be configured to execute the content switching processing for each of the plurality of the users.

In the above-mentioned content output control device, the output content switching unit may be configured to: output, when a situation in which the degree-of-immersion reduction state recognition unit recognizes the degree-of-immersion reduction state is continued even after the content switching processing is executed, a predetermined response request voice from a user speaker used by the user; and switch, when a response voice with respect to the response request voice is input to a user microphone used by the user, the content output from the content output device to third content that is based on the response voice.

In the above-mentioned content output control device, the output content switching unit may be configured to output, when the response voice is not input to the user microphone within a predetermined time from a time point at which the response request voice is output, a predetermined corresponding voice from a driver speaker used by a driver of the movable body.

In the above-mentioned content output control device, the output content switching unit may be configured to execute, when the response voice is not input to the user microphone within a predetermined time from a time point at which the response request voice is output, a route guide to a parkable place present around the movable body by a navigation device used in the movable body.

As a second aspect for achieving the above-mentioned object, there is given a content output control method to be executed by a computer, the content output control method including: a biological information acquisition step of acquiring biological information of a user aboard a movable body; a degree-of-immersion reduction state recognition step of recognizing, based on the biological information, that the user is in a degree-of-immersion reduction state indicating that a degree of immersion with respect to content output from a content output device used in the movable body is reduced; and an output content switching step of executing content switching processing of switching, while first content is output from the content output device, when the user is recognized to be in the degree-of-immersion reduction state in the degree-of-immersion reduction state recognition step, the content output from the content output device to second content that is different from the first content.

As a third aspect for achieving the above-mentioned object, there is given a non-transitory computer-readable storage medium storing a program for causing a computer to function as: a biological information acquisition unit configured to acquire biological information of a user aboard a movable body; a degree-of-immersion reduction state recognition unit configured to recognize, based on the biological information, that the user is in a degree-of-immersion reduction state indicating that a degree of immersion with respect to content output from a content output device used in the movable body is reduced; and an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.

With the above-mentioned content output control device, content output control method, and program, when the content output from the content output device used in the movable body such as a vehicle does not match the preference or mood of the user aboard the movable body, the content output from the content output device can be promptly switched.

### BRIEF DESCRIPTION OF THE DRAWINGS

FIG. 1 is an explanatory view of a vehicle on which a content output control device is installed;

FIG. 2 is a configuration diagram of the content output control device;

FIG. 3 is a first flowchart of output content switching processing; and

FIG. 4 is a second flowchart of the output content switching processing.

### DETAILED DESCRIPTION OF THE INVENTION

### 1. Usage Mode of Content Output Control Device

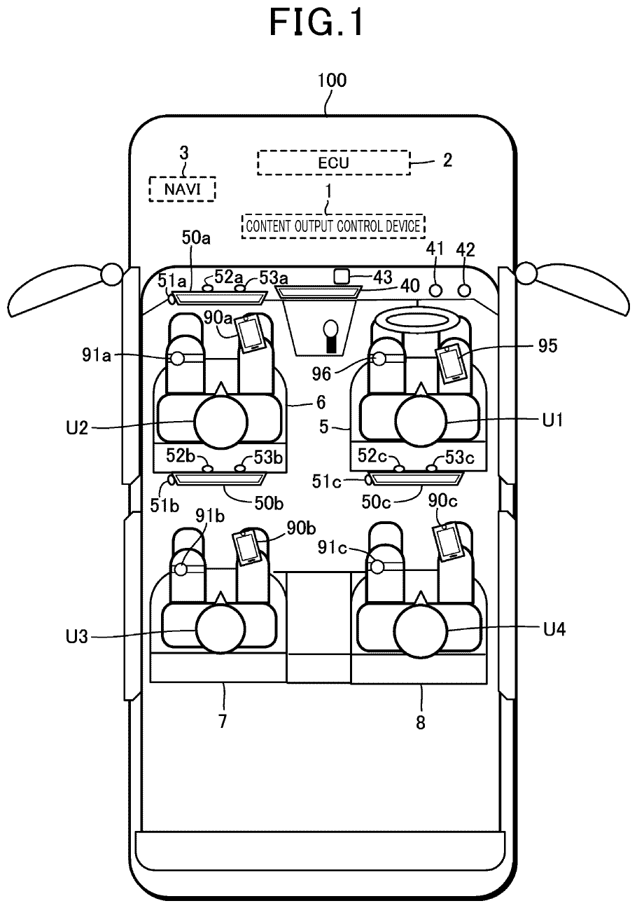

With reference to FIG. 1, a usage mode of a content output control device 1 of this embodiment is described. The content output control device 1 is installed on a vehicle 100. FIG. 1 illustrates a situation in which a user U1 sits on a driver seat 5, a user U2 sits on a passenger seat 6, a user U3 sits on a left rear seat 7, and a user U4 sits on a right rear seat 8. The vehicle 100 corresponds to a movable body of the present disclosure. The vehicle 100 includes an ECU (Electronic Control Unit) 2 that controls the operation of the vehicle 100, and a navigation device 3 that executes a route guide.

In this embodiment, the vehicle 100 includes, as a content output device that outputs content under control by the content output control device 1, a driver seat speaker 41 to be used by the user U1 (driver), a passenger seat display 50a and a passenger seat speaker 51a to be used by the user U2, a left rear seat display 50b and a left rear seat speaker 51b to be used by the user U3, and a right rear seat display 50c and a right rear seat speaker 51c to be used by the user U4. Further, when the ECU 2 included in the vehicle 100 performs traveling control by an automatic driving mode in which the traveling of the vehicle 100 is controlled regardless of a driving operation performed by the driver, the user U1 can continuously view the content displayed on a center display 40. Accordingly, at the time of traveling of the vehicle 100 by the automatic driving mode, the center display 40 also becomes the content output device which is a target of content output control by the content output control device 1. The content includes content including video and audio, content including only video and not including audio, and content including only audio and not including video.

The content output control device 1 performs wireless communication in a communication standard such as Bluetooth (registered trademark) with a communication terminal 95 held by the user U1 and a smartwatch 96 worn by the user U1, a communication terminal 90a held by the user U2 and a smartwatch 91a worn by the user U2, a communication terminal 90b held by the user U3 and a smartwatch 91b worn by the user U3, and a communication terminal 90c held by the user U4 and a smartwatch 91c worn by the user U4. The smartwatches 91a to 91c and 96 are wearable devices each having a function of detecting a heart rate of a wearer. Each of the communication terminals 90a to 90c and 95 and the smartwatches 91a to 91c and 96 includes a processor.

The content output control device 1 recognizes, for each of the users U1 to U4, reduction of a degree of immersion (a degree of interest, concern, and the like) with respect to the content output from the content output device based on biological information, and executes processing of switching the content output from the content output device. For example, for the user U3 siting on the left rear seat 7, the content output control device 1 acquires, as the biological information of the user U3, a taken image of the user U3 taken by a left rear seat camera 53b and a heart rate of the user U3 detected by the smartwatch 91b worn by the user U3.

### 2. Configuration of Content Output Control Device

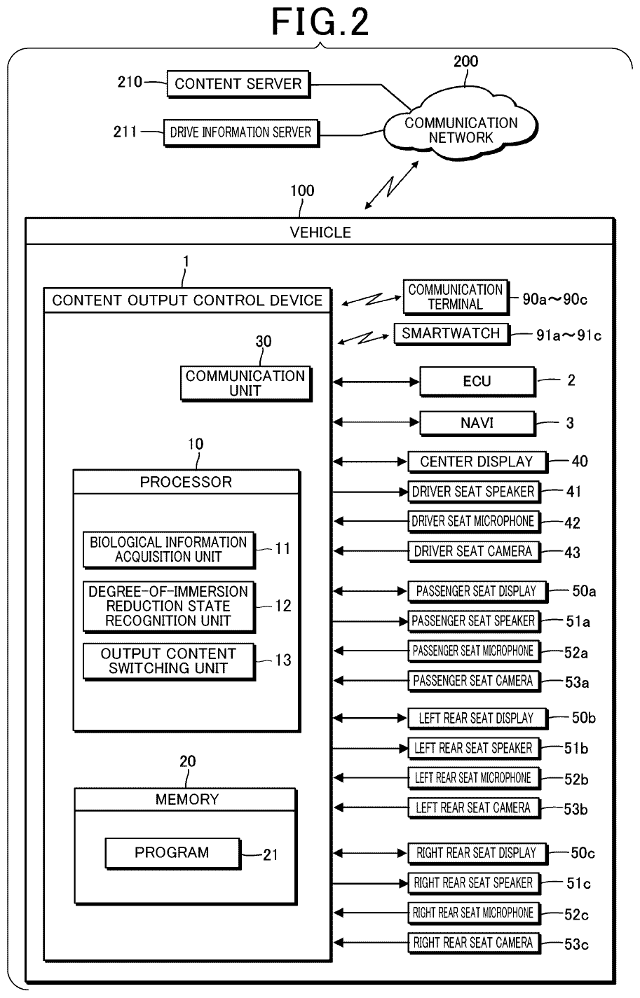

With reference to FIG. 2, the configuration of the content output control device 1 is described. The content output control device 1 is a control unit including a processor 10, a memory 20, a communication unit 30, and the like. The processor 10 corresponds to a computer of the present disclosure. The content output control device 1 performs, by the communication unit 30 including a transmitter and a receiver, communication with a content server 210, a drive information server 211, and the like via a communication network 200.

Further, the content output control device 1 performs, by the communication unit 30, wireless communication with the communication terminals 90a to 90c and 95 and the smartwatches 91a to 91c and 96 used in a vehicle cabin of the vehicle 100. The content output control device 1 is connected to the ECU 2, the navigation device 3, the center display 40, the driver seat speaker 41, a driver seat microphone 42, a driver seat camera 43, the passenger seat display 50a, the passenger seat speaker 51a, a passenger seat microphone 52a, a passenger seat camera 53a, the left rear seat display 50b, the left rear seat speaker 51b, a left rear seat microphone 52b, the left rear seat camera 53b, the right rear seat display 50c, the right rear seat speaker 51c, a right rear seat microphone 52c, and a right rear seat camera 53c.

The memory 20 of the content output control device 1 stores a program 21 for control of the content output control device 1. When the processor 10 reads and executes the program 21, the processor 10 functions as a biological information acquisition unit 11, a degree-of-immersion reduction state recognition unit 12, and an output content switching unit 13.

Processing to be executed by the biological information acquisition unit 11 corresponds to a biological information acquisition step in a content output control method of the present disclosure. Processing to be executed by the degree-of-immersion reduction state recognition unit 12 corresponds to a degree-of-immersion reduction state recognition step in the content output control method of the present disclosure. Processing to be executed by the output content switching unit 13 corresponds to an output content switching step in the content output control method of the present disclosure.

The biological information acquisition unit 11 acquires, as biological information of the user aboard the vehicle 100, an image (in particular, a face image) of the user and detection information on the heart rate of the user. For example, the biological information acquisition unit 11 acquires, for the user U3, an image of the user U3 taken by the left rear seat camera 53b and detection information on the heart rate of the user U3 detected by the smartwatch 91b. The biological information acquisition unit 11 acquires the image and the detection information on the heart rate similarly for each of the other users U1, U2, and U4.

The degree-of-immersion reduction state recognition unit 12 recognizes that each of the users U1 to U4 is in a degree-of-immersion reduction state indicating that the degree of immersion with respect to the output content is reduced. For example, the degree-of-immersion reduction state recognition unit 12 recognizes that the user U3 is in the degree-of-immersion reduction state with respect to the content output from the left rear seat display 50b and the left rear seat speaker 51b. The same holds true also for the other users U1, U2, and U4.

The degree-of-immersion reduction state recognition unit 12 recognizes that the user is in the degree-of-immersion reduction state when the degree-of-immersion reduction state recognition unit 12 recognizes, for example, any one of the following determination conditions 1 to 3 from the biological information of the user (the image of the user, the heart rate of the user).
Determination condition 1. . . . It is recognized from the image of the user that the line of sight of the user is directed to a direction other than the display (a direction of a window of the vehicle 100) (the user is not viewing the content displayed on the display).
Determination condition 2. . . . It is recognized from the image of the user or reduction of the heart rate that the user is sleeping.
Determination condition 3. . . . It is recognized from the image of the user or increase of the heart rate that the user being a young person is fussy.

The output content switching unit 13 executes content switching processing of switching the output content for the user that has been recognized to be in the degree-of-immersion reduction state by the degree-of-immersion reduction state recognition unit 12. For example, when it is recognized that the user U3 siting on the left rear seat 7 is in the degree-of-immersion reduction state, the output content switching unit 13 switches the content output from the left rear seat display 50b and the left rear seat speaker 51b to other content. The same holds true also for the other users U1, U2, and U4.

### 3. Processing of Switching Output Content

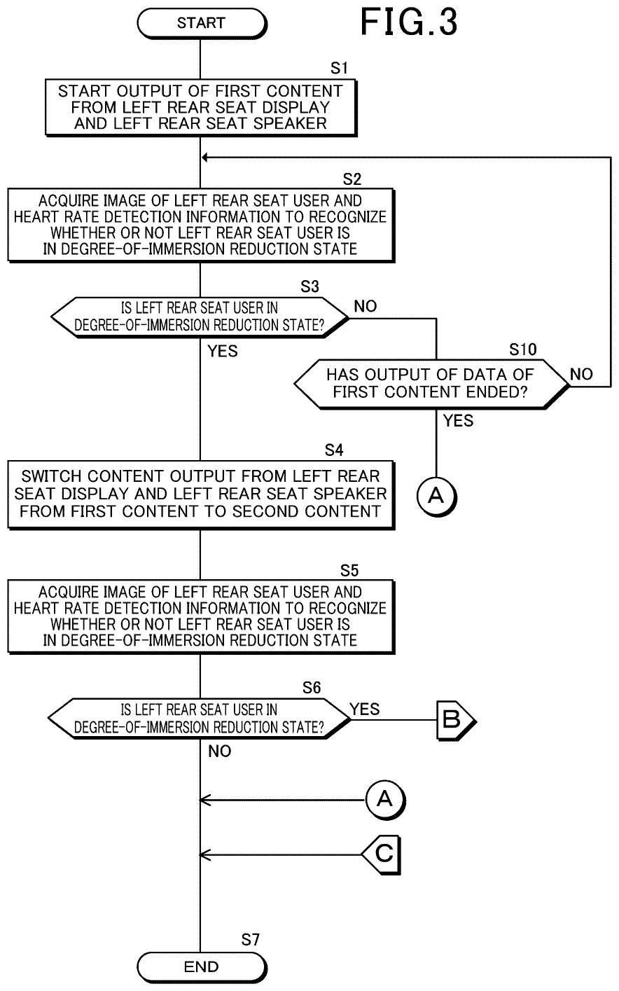

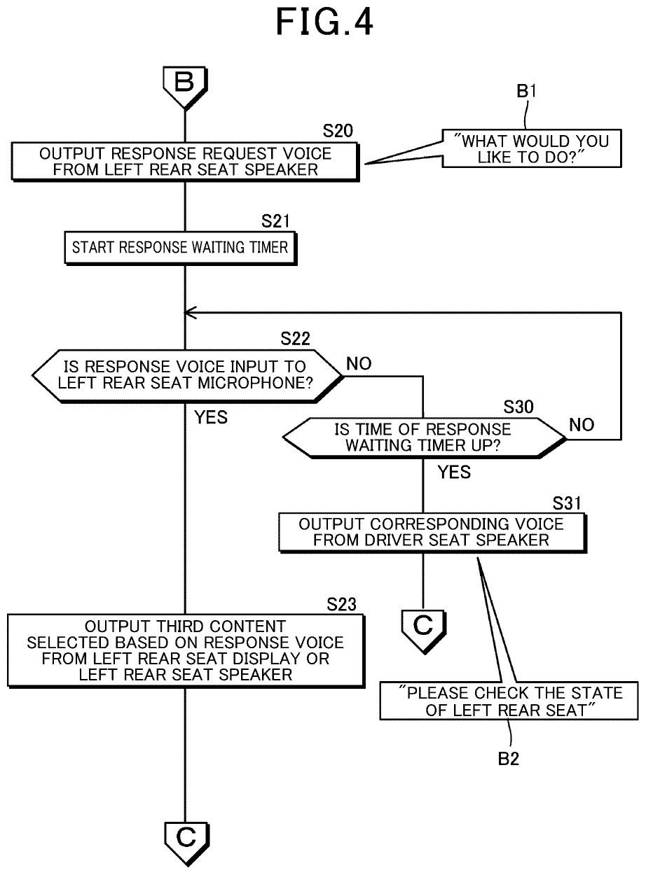

In accordance with the flowcharts of FIG. 3 and FIG. 4, the procedure of the processing of switching the output content executed by the content output control device 1 is described. FIG. 3 and FIG. 4 illustrate processing executed for the user U3 siting on the left rear seat 7 as a target. The content output control device 1 executes similar processing also for the users U1, U2, and U4 siting on other seats.

In Step S1 of FIG. 3, the output content switching unit 13 starts output of first content from the left rear seat display 50b and the left rear seat speaker 51b. The first content is content that outputs video and audio. The output content switching unit 13 makes an access to the content server 210 by the communication unit 30 to acquire data of the first content. It is to be noted that the data of the first content may be read from a recording medium (a magnetic disk, an optical disk, a memory card, etc.).

In subsequent Step S2, the biological information acquisition unit 11 acquires, as the biological information of the user U3, the image of the user U3 taken by the left rear seat camera 53b and the detection information on the heart rate of the user U3 transmitted from the smartwatch 91b worn by the user U3. Further, the degree-of-immersion reduction state recognition unit 12 recognizes, based on the biological information of the user U3, whether or not the user U3 is in the degree-of-immersion reduction state with reference to the above-mentioned determination conditions 1 to 3.

In subsequent Step S3, the output content switching unit 13 advances the processing to Step S4 when the user U3 is in the degree-of-immersion reduction state, and advances the processing to Step S10 when the user U3 is not in the degree-of-immersion reduction state. In Step S10, the output content switching unit 13 determines whether or not the output (reproduction) of the data of the first content has ended. Then, the output content switching unit 13 advances the processing to Step S7 when the output of the data of the first content has ended, and returns the processing to Step S2 when the output of the data of the first content has not ended.

In Step S4, the output content switching unit 13 switches the content output from the left rear seat display 50b and the left rear seat speaker 51b from the first content to second content. Here, the first content and the second content are different types of content. When the first content is content including video and audio, content including only audio may be selected as the second content.

In next Step S5, the biological information acquisition unit 11 acquires, as the biological information of the user U3, the image of the user U3 taken by the left rear seat camera 53b and the detection information on the heart rate of the user U3 transmitted from the smartwatch 91b worn by the user U3. Further, the degree-of-immersion reduction state recognition unit 12 recognizes, based on the biological information of the user U3, whether or not the user U3 is in the degree-of-immersion reduction state with reference to the above-mentioned determination conditions 1 to 3.

In subsequent Step S6, the output content switching unit 13 advances the processing to Step S20 of FIG. 4 when the user U3 is in the degree-of-immersion reduction state, and advances the processing to Step S7 when the user U3 is not in the degree-of-immersion reduction state and the user U3 can be determined to be immersed in the second content.

In Step S20 of FIG. 4, the output content switching unit 13 outputs, from the left rear seat speaker 51b to the user U3, a response request voice that requests a response such as, as exemplified by a speech bubble B1, “What would you like to do?”. In subsequent Step S21, the output content switching unit 13 starts a response waiting timer. Through the loop processing of next Step S22 and Step S30, in Step S22, the output content switching unit 13 waits until a voice of the user U3 is input to the left rear seat microphone 52b until the time of the response waiting timer is up in Step S30.

The output content switching unit 13 advances the processing to Step S23 when the response voice of the user U3 is input to the left rear seat microphone 52b. In Step S23, the output content switching unit 13 analyzes the response voice of the user U3 to extract an utterance text, and selects third content corresponding to the utterance text. Then, the output content switching unit 13 outputs the selected third content from the left rear seat display 50b and the left rear seat speaker 51b.

Further, the output content switching unit 13 advances the processing from Step S30 to Step S31 when the time of the response waiting timer is up. In Step S31, the output content switching unit 13 outputs, from the driver seat speaker 41, a corresponding voice such as, as exemplified by a speech bubble B2, “Please check the state of left rear seat”. In this manner, when it is estimated that the user U3 is in a state of sleeping or not feeling well because there is no response, it is possible to urge the user U1 (driver) to check the state of the user U3.

### 4. Other Embodiments

In the above-mentioned embodiment, the vehicle 100 has been exemplified as the movable body of the present disclosure, but the invention of the present application is applicable also to other types of movable bodies (an aircraft, a ship, etc.) in which an occupant views and listens to the content output from the content output device.

In the above-mentioned embodiment, the output content switching unit 13 outputs the content from the displays 50a to 50c and 40 and the speakers 51a to 51c and 41 included in the vehicle 100. As another embodiment, there may be employed a configuration in which the content is output through wireless communication with the communication terminals 90a to 90c and 95 from display units and speakers of the communication terminals 90a to 90c and 95.

In the above-mentioned embodiment, the content output control device 1 included in the vehicle 100 is exemplified, but the content output control device of the present disclosure may be configured as a function of the content server 210 or the like. In this case, the biological information of the user aboard the vehicle 100 is transmitted to the content server 210, and the content server 210 is configured to recognize that the user is in the degree-of-immersion reduction state and switch the content transmitted to the vehicle 100.

Further, the content output device of the present disclosure may be configured as a function of an application (application program) of the communication terminals 90a to 90c and 95. In this case, the content output device of the present disclosure can be configured of the communication terminal alone by taking an image of the user by a built-in camera of the communication terminal to acquire the image of the user, and outputting the content from the display unit and the speaker of the communication terminal. Further, through communication between the communication terminal and the ECU 2 of the vehicle 100, the content output from the displays 50a to 50c and 40 and the speakers 51a to 51c and 41 included in the vehicle 100 may be switched by the application of the communication terminal.

In the processing shown in the flowchart of FIG. 3, when it is recognized that the user is in the degree-of-immersion reduction state in Step S3, in Step S4, the content output from the display and the speaker is immediately switched from the first content to the second content. As another embodiment, the switching timing from the first content to the second content may be set by the following modification examples 1 and 2.
Modification example 1. . . . At a time point at which the user is recognized to be in the degree-of-immersion reduction state, when the remaining time of the output of the data of the first content is a short time equal to or less than a predetermined time, the end of the output of the data of the first content is waited, and the first content is switched to the second content at a good time point at which the output of the data of the first content is ended. For example, when the output (reproduction) of the first content will end in three minutes, the first content is switched to the second content after three minutes elapse and the output of the first content is ended.
Modification example 2. . . . At a time point at which the user is recognized to be in the degree-of-immersion reduction state, when the remaining time of the output of the data of the first content is a long time that is more than the predetermined time, it is estimated that the user does not desire to continuously view the first content that the user is already bored of, and hence the output of the first content is ended in the middle to switch the first content to the second content.

In the above-mentioned embodiment, through the processing of Steps S30 and S31 of FIG. 4, when there is no response from the user that has been recognized to be in the degree-of-immersion reduction state, the corresponding voice is output to the driver. As another embodiment, when there is no response from the user that has been recognized to be in the degree-of-immersion reduction state, a route guide to a parkable place around the current position of the vehicle 100 may be executed by the navigation device included in the vehicle 100.

In the above-mentioned embodiment, the image and the heart rate of the user are exemplified as the biological information of the user, but other types of biological information may be used. For example, the degree-of-immersion reduction state recognition unit 12 may use other types of biological information such as brain waves, a perspiration state, a body temperature, a pulse, and the like of the user to recognize that the user is in the degree-of-immersion reduction state.

It is to be noted that FIG. 2 is a schematic diagram illustrating configurations of the content output control device 1, the configurations being sectioned depending on main processing contents for ease of understanding of the invention of the present application. The configurations of the content output control device 1 may be sectioned otherwise. Further, the processing in each component may be executed by one hardware unit, or may be executed by a plurality of hardware units. Further, the processing in each component illustrated in FIG. 3 and FIG. 4 may be executed by one program, or may be executed by a plurality of programs.

### 5. Configurations Supported by Above-mentioned Embodiment

The above-mentioned embodiment is a specific example of the following configurations.

(Configuration 1) A content output control device including: a biological information acquisition unit configured to acquire biological information of a user aboard a movable body; a degree-of-immersion reduction state recognition unit configured to recognize, based on the biological information, that the user is in a degree-of-immersion reduction state indicating that a degree of immersion with respect to content output from a content output device used in the movable body is reduced; and an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.

With the content output control device described in Configuration 1, when the content output from the content output device used in the movable body does not match the preference or mood of the user aboard the movable body, the content output from the content output device can be promptly switched.

(Configuration 2) The content output control device according to Configuration 1, in which the output content switching unit is configured to switch, while the first content being video is output from the content output device, when the degree-of-immersion reduction state recognition unit recognizes that the user is in the degree-of-immersion reduction state, the first content to the second content that outputs only audio without outputting video by the content switching processing.

With the content output control device described in Configuration 2, when it is estimated that the user is not in interest of the video content, the content is switched to the content that outputs only audio to support the comfortable movement of the user.

(Configuration 3) The content output control device according to Configuration 1 or Configuration 2, in which the output content switching unit is configured to execute switching from the first content to the second content by the content switching processing at a timing at which output of data of the first content is completed.

With the content output control device described in Configuration 3, it is possible to prevent the user from feeling strange or discomfort because of the sudden cancel of the output of the first content in the middle of the output of the data of the first content.

(Configuration 4) The content output control device according to any one of Configuration 1 to Configuration 3, in which: the biological information acquisition unit is configured to individually acquire biological information of a plurality of the users aboard the movable body; the degree-of-immersion reduction state recognition unit is configured to recognize, for each of the plurality of the users, based on the biological information acquired by the biological information acquisition unit, the degree-of-immersion reduction state indicating that the degree of immersion with respect to the content output from the content output device used by the user is reduced; and the output content switching unit is configured to execute the content switching processing for each of the plurality of the users.

With the content output control device described in Configuration 4, in a case where a plurality of users are aboard the movable body, it is possible to promptly switch the content output from the content output device to other content for each user when the degree-of-immersion reduction state is recognized.

(Configuration 5) The content output control device according to any one of Configuration 1 to Configuration 4, in which the output content switching unit is configured to: output, when a situation in which the degree-of-immersion reduction state recognition unit recognizes the degree-of-immersion reduction state is continued even after the content switching processing is executed, a predetermined response request voice from a user speaker used by the user; and switch, when a response voice with respect to the response request voice is input to a user microphone used by the user, the content output from the content output device to third content that is based on the response voice.

With the content output control device described in Configuration 5, when the degree-of-immersion reduction state of the user is continuously recognized even after the content output from the content output device is switched by the content switching processing, the content can be switched to content desired by the user based on the response voice from the user.

(Configuration 6) The content output control device according to Configuration 5, in which the output content switching unit is configured to output, when the response voice is not input to the user microphone within a predetermined time from a time point at which the response request voice is output, a predetermined corresponding voice from a driver speaker used by a driver of the movable body.

With the content output control device described in Configuration 6, when the user is possibly in a state of sleeping or not feeling well because there is no input of the response voice of the user with respect to the response request voice, it is possible to urge the driver to respond to the state.

(Configuration 7) The content output control device according to Configuration 5, in which the output content switching unit is configured to execute, when the response voice is not input to the user microphone within a predetermined time from a time point at which the response request voice is output, a route guide to a parkable place present around the movable body by a navigation device used in the movable body.

With the content output control device described in Configuration 7, when the user is possibly in a state of sleeping or not feeling well because there is no input of the response voice of the user with respect to the response request voice, it is possible to urge the driver to stop the movable body and check the state of the user.

(Configuration 8) A content output control method to be executed by a computer, the content output control method including: a biological information acquisition step of acquiring biological information of a user aboard a movable body; a degree-of-immersion reduction state recognition step of recognizing, based on the biological information, that the user is in a degree-of-immersion reduction state indicating that a degree of immersion with respect to content output from a content output device used in the movable body is reduced; and an output content switching step of executing content switching processing of switching, while first content is output from the content output device, when the user is recognized to be in the degree-of-immersion reduction state in the degree-of-immersion reduction state recognition step, the content output from the content output device to second content that is different from the first content.

With the content output control method of Configuration 8 being executed by the computer, actions and effects similar to those of the content output control device of Configuration 1 can be obtained.

(Configuration 9) A program for causing a computer to function as: a biological information acquisition unit configured to acquire biological information of a user aboard a movable body; a degree-of-immersion reduction state recognition unit configured to recognize, based on the biological information, that the user is in a degree-of-immersion reduction state indicating that a degree of immersion with respect to content output from a content output device used in the movable body is reduced; and an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.

With the program of Configuration 9 being executed by the computer, the configuration of the content output control device of Configuration 1 can be achieved.

### REFERENCE SIGNS LIST

1 . . . content output control device, 2. . . . ECU, 3 . . . navigation device, 10 ··· processor, 11 . . . biological information acquisition unit, 12 . . . degree-of-immersion reduction state recognition unit, 13 . . . output content switching unit, 20 . . . memory, 21 . . . program, 30 . . . communication unit, 40 . . . center display, 41 . . . driver seat speaker, 42 . . . driver seat microphone, 43 . . . driver seat camera, 50a . . . passenger seat display, 51a . . . passenger seat speaker, 52a . . . passenger seat microphone, 53a . . . passenger seat camera, 50b . . . left rear seat display, 51b . . . left rear seat speaker, 52b . . . left rear seat microphone, 53b . . . left rear seat camera, 50c . . . right rear seat display, 51c . . . right rear seat speaker, 52c . . . right rear seat microphone, 53 . . . right rear seat camera, 100 . . . vehicle (movable body), 200 . . . communication network, 210 . . . content server, 211 . . . drive information server, U1-U4 . . . user.

1. A content output control device comprising:
a biological information acquisition unit configured to acquire biological information of a user aboard a movable body;
a degree-of-immersion reduction state recognition unit configured to recognize, based on the biological information, that the user is in a degree-of-immersion reduction state indicating that a degree of immersion with respect to content output from a content output device used in the movable body is reduced; and
an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.

2. The content output control device according to claim 1, wherein the output content switching unit is configured to switch, while the first content being video is output from the content output device, when the degree-of-immersion reduction state recognition unit recognizes that the user is in the degree-of-immersion reduction state, the first content to the second content that outputs only audio without outputting video by the content switching processing.

3. The content output control device according to claim 1, wherein the output content switching unit is configured to execute switching from the first content to the second content by the content switching processing at a timing at which output of data of the first content is completed.

4. The content output control device according to claim 1, wherein:
the biological information acquisition unit is configured to individually acquire biological information of a plurality of the users aboard the movable body;
the degree-of-immersion reduction state recognition unit is configured to recognize, for each of the plurality of the users, based on the biological information acquired by the biological information acquisition unit, the degree-of-immersion reduction state indicating that the degree of immersion with respect to the content output from the content output device used by the user is reduced; and
the output content switching unit is configured to execute the content switching processing for each of the plurality of the users.

5. The content output control device according to claim 1, wherein the output content switching unit is configured to:
output, when a situation in which the degree-of-immersion reduction state recognition unit recognizes the degree-of-immersion reduction state is continued even after the content switching processing is executed, a predetermined response request voice from a user speaker used by the user; and
switch, when a response voice with respect to the response request voice is input to a user microphone used by the user, the content output from the content output device to third content that is based on the response voice.

6. The content output control device according to claim 5, wherein the output content switching unit is configured to output, when the response voice is not input to the user microphone within a predetermined time from a time point at which the response request voice is output, a predetermined corresponding voice from a driver speaker used by a driver of the movable body.

7. The content output control device according to claim 5, wherein the output content switching unit is configured to execute, when the response voice is not input to the user microphone within a predetermined time from a time point at which the response request voice is output, a route guide to a parkable place present around the movable body by a navigation device used in the movable body.

8. A content output control method to be executed by a computer, the content output control method comprising:
a biological information acquisition step of acquiring biological information of a user aboard a movable body;
a degree-of-immersion reduction state recognition step of recognizing, based on the biological information, that the user is in a degree-of-immersion reduction state indicating that a degree of immersion with respect to content output from a content output device used in the movable body is reduced; and
an output content switching step of executing content switching processing of switching, while first content is output from the content output device, when the user is recognized to be in the degree-of-immersion reduction state in the degree-of-immersion reduction state recognition step, the content output from the content output device to second content that is different from the first content.

9. A non-transitory computer-readable storage medium storing a program for causing a computer to function as:
a biological information acquisition unit configured to acquire biological information of a user aboard a movable body;
a degree-of-immersion reduction state recognition unit configured to recognize, based on the biological information, that the user is in a degree-of-immersion reduction state indicating that a degree of immersion with respect to content output from a content output device used in the movable body is reduced; and
an output content switching unit configured to execute content switching processing of switching, while first content is output from the content output device, when the degree-of-immersion reduction state recognition unit recognizes that the user is in the degree-of-immersion reduction state, the content output from the content output device to second content that is different from the first content.
